(19) United States
(12) Patent Application Publication
(10) Pub. No.: US 2004/0080131 A1
(43) Pub. Date: Apr. 29, 2004

(54) Securing device for a wheel carrier

(76) Inventors: Gerold Pankl, Bruck an der Mur (AT); Jochen Domschitz, Kittsee (AT)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/141,788

(22) Filed: May 8, 2002

(30) Foreign Application Priority Data
Apr. 10, 2002 (EP) EP 02450082.9

(51) Int. Cl. B60G 1/00

(52) U.S. Cl. 280/93.511

(57) ABSTRACT

The invention concerns the securing of the wheel carrier of a driven wheel of a motor vehicle, especially a racing or sports vehicle, on the chassis, wherein the force transfer of the drive runs from a chassis-side part of an inside universal joint (6), then through the shaft-side part of the universal joint, a drive shaft (7), a shaft-side part of an outside universal joint (5), and a wheel carrier-side part of this universal joint, to the wheel carrier (3).

The invention is characterized in that the chassis-side part of the inside universal joint (6) is connected with the wheel carrier-side part of the outside universal joint (5) in an undetachable manner.

This connection can be created via the drive shaft or via a cable conducted in it. In the first case, the drive shaft can be secured in its front area via rods (8,11) or, especially in the case of a tripod, via the star.

The invention concerns a securing device of the wheel, or of a wheel carrier, of a motor vehicle, particularly a racing or sports vehicle.

In the course of vehicle accidents, it repeatedly occurs that wheel carriers, together with the wheels mounted on them and perhaps brakes, etc., are torn off the wheel suspension and are released from the wrecked vehicle at a high speed and over a certain area, wherein they are a great danger for the health and life of persons who are in the vicinity. Also, the damage to objects in the surrounding areas are apparent.

This danger is very high, especially with sports vehicles in which, because of the handling characteristics of the vehicles (low unsprung mass), one attempts to keep the mass of the wheel suspension as low as possible. At the same time, it is precisely these motor vehicles, as can be seen in particular in Formula I, have tires that, as a result of their size, bring a high danger potential. In addition, particularly in Formula I, but also in other formulas and even in rally sport, there are the traveled speeds, which make themselves noticeable with detached tires and wheel carriers, not only with respect to their kinetic energy, but also their mass moment of inertia.

These problems are particularly acute since, in the area of the wheel suspension, more and more components are no longer made of metal, but rather of nonmetal composite material (coiled carbon fibers, Kevlar fibers, and so forth). These materials have a higher strength than steel, but an overloading does not lead to plastic deformation but rather to a fracture, particularly a continuous brittle fracture, so that precisely in the case of accidents, the connection between the chassis and the wheel carrier is suddenly lost.

In some areas of motor sports, for example, in Formula I, in recent times as the result of a change in rules, there has been an absolute demand for an emergency connection device between the wheel carrier and the chassis, but in view of the principles of racing, this is only an emergency solution since such a securing line (mostly a cable) makes necessary the creation of fastening points on the chassis and on the wheel carrier, and moreover impairs the rapid and nonproblematic dismantling of the wheel suspension. In addition, there is the danger that the securing line is not properly fixed on both sides, which not only means that there is no emergency fixing of the wheel carrier, but rather this creates the new danger that the line will be lost and will injure persons or damage objects.

The invention aims at creating a wheel securing device that will not have the aforementioned disadvantages, but rather is created in the course of the installation of the wheel suspension and is detached in the course of the dismantling of the wheel suspension, simply and desirably without additional components or assembly steps.

Driven wheels have a drive shaft, which on one end is supported in a tripod on the differential, or at least on the differential side, and on the other end is supported in a tripod of the wheel carrier. The drive shaft is introduced into at least one tripod with sufficient axial play in order to be able to compensate for the length change between the tripod centers, which appear in the course of the spring deflecting and rebounding, and perhaps the steering movement.

In accordance with the invention, the plan is to link the two tripods with one another in an undetachable manner, more precisely their wheel carrier-side part and their differential-side part, preferably with the drive shaft. In this way, the action of the securing device will take place during the dismantling of the wheel carrier and, during the installation [of the wheel suspension], the securing device is activated at the same time, so that it cannot fail [to be activated] in any case.

Moreover, since the drive shaft itself is created for transferring great forces and, particularly with racing cars, since the most massive individual part is in the area of the wheel suspension, this component can, without further change, take over the securing device task, only by its secure axial fixing on the chassis-that is, the differential-on the one hand, and on the wheel carrier on the other hand.

In a variant of the invention, a steel cable, which is secured with its chassis-side end and which rotates along with the drive shaft, is conducted through the hollow drive shaft; the steel cable has a pull-out safety catch, which can perhaps be detached, on its end on the “outside” of the vehicle in the area of the wheel bearing.

If it is sufficient that the drive shaft only, including the tripod, is replaced; the easy detachability of the securing device can then be omitted and it is ensured, by a measure in accordance with the invention, that the wheel carrier, together with the wheel rim and tire, cannot leave the vehicle chassis, even with a complete fracture of the wheel suspension. Since with racing cars the drive line from the differential is replaced at the same time, this last-mentioned solution is the preferred one and is explained in more detail below, with the aid of drawings. The figures show the following:

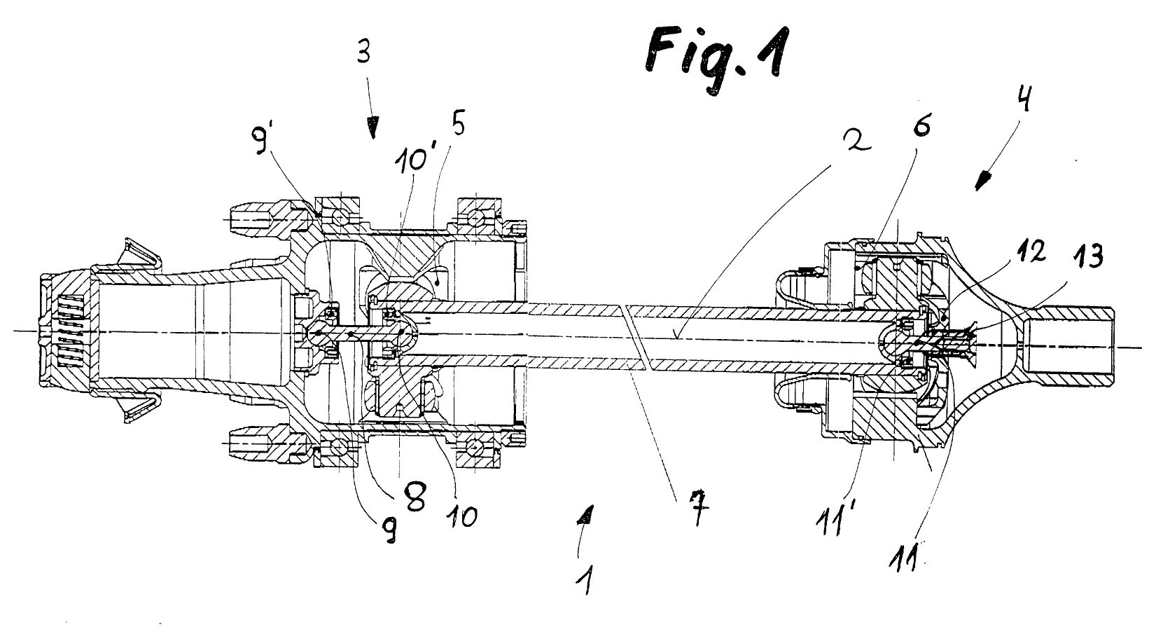

FIG. 1, a section through a semi-axle, designed in accordance with the invention and

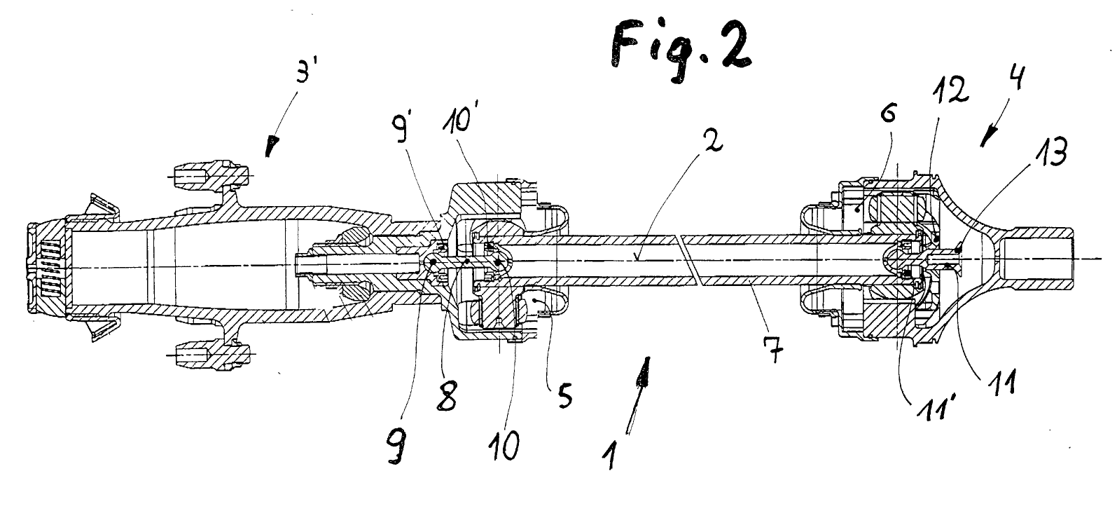

FIG. 2, a variant of FIG. 1.

FIG. 1 shows, in a section through the rotating axle 2, a semi-axle, designated in its totality with 1, in the stretched state. The semi-axle carries a wheel carrier 3 on one of its ends and a connecting piece 4 to a gear system or differential on its other end. By means of a tripod 5, 6, it is connected with the wheel carrier 3 or the connecting piece 4. For reasons of clarity, the actual wheel suspension—which leads from the chassis of the vehicle, on the right side of the representation of FIG. 1, to the wheel carrier 3, and holds it and guides it—is not depicted. In the course of movement of the wheel carrier 3, with respect to the connecting piece 4, which is stationary except for the rotations of the axle 2, if it is a steered axle, there is a change in the distance between the center of the two tripods 5, 6 because of the steering movement.

In order not to have the position of the drive shaft 7 out of the permissible area with this length change, from the state of the art, which is best represented by European Patent No. 0,968,867 A1 of the applicant, acting on the semi-axle 7 with a compression spring from one side, preferably from the side of the differential, the connecting piece 4 is pressed against a corresponding stop with one of the ends [of the drive shaft] and thus assumes an always defined position. A part of this previously known construction is represented by the pressure rod 8 in the exemplified embodiment of the invention shown. In addition, it must be said that the designation “pressure rod” has more a historical than technical justification, since in the construction in accordance with the publication above, this component is actually constantly placed under pressure by the spring on the other end of the drive shaft, whereas it is under pressure or traction with the same frequency in the construction in accordance with the invention.

In a known manner, the pressure rod 8 has spherical thickenings 9, 10, on both ends, which rest in corresponding receptacles or outer supports of the wheel bearing 3, on the one hand, and [in supports] of the drive shaft 7, on the other hand.

On the other end of the drive shaft 7, a similar device is provided in accordance with the invention, wherein a holding rod 11 is provided instead of a pressure rod; this rod, with a likewise spherically designed end, sits in a receptacle of the drive shaft 7; with its other end, it projects, with an excess length, through a recess 12 of the receptacle 4 and has a thickening 13 at the end of the excess length.

In accordance with the invention, the pressure rod 8 is fixed, by means of securing rings 9′, 10′, in its position with respect to its receptacles in the wheel carrier 3, on the one hand, and the drive shaft 7, on the other hand so that—with the exception of the slight movement of the drive shaft 7, with respect to the center of the tripod 5, with oblique adjustments, which the pressure rod 8 does not follow or does so only partially—the wheel carrier is fixed with respect to the drive wheel.

The other vehicle-side end of the drive shaft 7 is held by the holding rod 11 and a corresponding securing device 11′, so as to hold the excess length of the holding rod 11 in a manner that permits it to slide in the connecting piece 4, so that the mode of functioning of the force transfer is not impaired with either a change in position or direction of the wheel carrier, with respect to the connecting piece.

However, if there is a tearing or breaking of the wheel suspension, the wheel carrier 3 remains joined with the connecting piece 4 via the pressure rod 8, the drive shaft 7, and the holding rod 11. The securing contrivances 9′, 10′, and 11′, by means of which the connecting elements of this dynamic chain are held together, are, for example, Seeger circlip rings or other machine elements, used as shaft or bearing securing devices that can be easily selected and dimensioned by an expert who knows the invention.

FIG. 2 shows a completely analogously constructed variant, in which only the wheel carrier 3′ is designed differently from the wheel carrier 3; the other components have the same mode of functioning and the same structure.

One can easily see from the representation and the explanations that one can also omit conducting any needed holding force between the two outer tripod parts via the drive shaft 7; thus, it is possible to design the pressure rod 8 and the holding rod 11 to be hollow and, like pearls on a string, to fix them on a suitable cable in order to attain a securing contrivance for the case in which the drive shaft 7 has a tendency toward brittle fracture, as has already happened on various occasions. Of course, in this case, the outer supports for the thickenings of rods 8, 11 are to also be provided with a central opening in the drive shaft 7, so as to permit passage of the cable.

In a development of this variant with a cable, it is of course also possible to dispense with the pressure rod 8 and the holding rod 11 and instead to provide only the cable on which four spheres (or four articles that have, at least in partial areas, a spherical surface) are fastened, for example, or are soldered on.

If the connection between the shaft-side tripod element (star [star-like device]) and the shaft is stable enough in the axial direction, for example, with a one-piece design of the shaft with the axle journals for the roller bodies of the tripod, it is also possible to provide arc-shaped holding disks or holding elements on the outer tripod elements (of the bell [bell-like device]) on the open end, by means of which the star is prevented from being drawn out of the bell in the longitudinal direction. With this embodiment, it is of course inevitable that any needed holding force will be transferred via the drive shaft 7.

What is important in the end is to connect the chassis-side part of the inside universal joint, in an undetachable manner, with the wheel carrier-side part of the outside universal joint. “Undetachable” in the sense of the invention is understood to mean that no separation or fracture occurs up to a prespecified pulling-out force.

In the evaluation of the invention, it has been kept in mind that during orderly operation, the holding device is exposed to almost no forces. Thus, with the embodiment described, only the pressure rod 8 is under stress, and is under such stress only during the change in the spring deflection or the change in the turning of a steered wheel. Even in this case, the only force that it has to transfer is a slight shifting movement of the drive shaft 7 and its two stars, with respect to at least one bell of the two tripods. If one disregards extremely seldom cases of spring deflection with a vehicle standing still or the actuation of the steering with a vehicle standing still, this movement always occurs during the rotation of the entire shown device around the axle 2, so that only a slight sliding friction occurs and so that only the mass forces of the drive shaft 7, together with the two stars, have to be overcome. The securing device thus has to be designed and dimensioned only for the case of its use, since until its activation no appreciable load, impairment, or wear can occur.

The invention is, of course, not limited to the shown example of a semi-axle of an extreme-racing vehicle, but rather can be used favorably with all sports vehicles. The use of tripods is also not an indispensable prerequisite for the use of the characterizing features of the invention, even when using a so-called “constant velocity” joint or when using two such joints; this is also true when using other universal joints.

For the specialist in the areas of the concept, design, and production of wheel suspensions, steerings, and drives for sports and race cars, it is easy, with a knowledge of the invention, to undertake the corresponding adaptations to a prespecified wheel suspension or semi-axis, in order to develop them in accordance with the invention. This is particularly true for the calculation of the necessary dimensions and wall thicknesses, so as to attain a prespecified holding force for the materials and for processing methods that are going to be used for such.

1. Securing device of the wheel carrier of a driven wheel of a motor vehicle, especially a racing or sports vehicle, on the chassis, wherein the force transfer of the drive runs from a chassis-side part of an inside universal joint (6), then through the shaft-side part of this universal joint, a drive shaft (7), a shaft-side part of an outside universal joint (5), and a wheel carrier-side part of this universal joint, to the wheel carrier (3), characterized in that the chassis-side part of the inside universal joint (6) is connected with the wheel carrier-side part of the outside universal joint (5) in an undetachable manner.

2. Securing device according to claim 1, characterized in that the connection is created by a pressure rod (8) and a holding rod (11); that one of the rods (8,11) connects the chassis-side part of the inside universal joint (6) with the drive shaft (7) and the other rod (11,8) connects the drive shaft (7) with the wheel carrier-side part of the outside universal joint (5); and that at least one of the rods (8,11) permits an axial play of the two parts connected by it.

3. Securing device according to claim 1, characterized in that a cable, conducted through the drive shaft (7), which is designed to be hollow, is connected on the one hand with the chassis-side part of the inside universal joint (6), and on the other hand with the wheel carrier-side part of the outside universal joint (5).

4. Securing device according to claim 3, characterized in that the cable carries stops, thickenings, or the like to position the drive shaft (7) with respect to the universal joints (5,6).

5. Securing device according to claim 1, characterized in that on the shaft-side of the chassis-side part of the inside universal joint (6) and on the shaft-side end of the wheel carrier-side part of the outside universal joint (5), stops, preferably in the form of plates, are affixed, which limit the axial movement of the drive shaft (7) with respect to the individual universal joint (5,6).
